(19) United States
(12) Patent Application Publication
(10) Pub. No.: US 2016/0016568 A1
(43) Pub. Date: Jan. 21, 2016

(54) BRAKE DEVICE

(71) Applicant: ADVICS CO., LTD., Aichi (JP)

(72) Inventors: Satoshi ISHIDA, Chiryu-city (JP); Yoshinori SUZUKI, Handa-city (JP)

(73) Assignee: ADVICS CO., LTD., Kariya-city, Aichi-pref. (JP)

(21) Appl. No.: 14/773,061

(22) PCT Filed: Mar. 6, 2014
(86) PCT No.: PCT/JP2014/055816

§ 371 Date: Sep. 4, 2015

(30) Foreign Application Priority Data
Mar. 6, 2013 (JP) 2013-044366

(51) Int. Cl. B60T 8/40; B60T 7/04

(52) U.S. Cl. CPC B60T 8/409; B60T 7/042; B60T 8/4086

(57) ABSTRACT

Both characteristics of brake fluid pressure output from an M/C with respect to an operation amount of a brake operating member, and characteristics of brake fluid pressure with respect to an operation force of the brake operating member can be varied. Adjustment dials are provided in a position that can be operated by a driver, and based on operation of the adjustment dials, F-P characteristics or St-P characteristics and St-F characteristics can be changed. In this manner, it is possible to adjust braking characteristics in accordance with a requirement of the driver. Then, by setting the operation of the adjustment dials to an adjustable range that takes into account safety of a vehicle, the driver can freely change the braking characteristics within that range in accordance with his/her own preferences. In this manner, it is possible to provide a new and comfortable driving environment for the driver.

### TECHNICAL FIELD

The present invention relates to a brake device that is capable of varying braking characteristics in accordance with a driver requirement.

### BACKGROUND ART

In related art, in Patent Literature 1, a brake device is proposed that is configured by a brake by wire system that is able to reduce costs while improving adjustability of a desired braking pressure inside a wheel cylinder (hereinafter referred to as a W/C). In this brake device, W/C pressure is generated based on hydraulic pressure of a power source that is configured by a pump, and a motor and an accumulator. Using an inflow valve (a pressure increase control valve) and an outflow valve (a pressure decrease control valve) that are installed for the W/C of each vehicle wheel, brake fluid is supplied to and discharged from inside each W/C individually, and each W/C pressure is thus controlled. Further, a pedal feeling at a time of braking is created by a so-called stroke simulator. Then, at a time of failure of the power source, the W/C is pressurized based on a pedal depression force by a driver, using a master cylinder (hereinafter referred to as an M/C) to compensate for failure that is directly connected to a brake pedal.

### CITATION LIST

### Patent Literature

### [PTL 1]

Japanese Patent Application Publication No. JP-A-10-86804

### SUMMARY OF INVENTION

### Technical Problem

In the above-described type of brake by wire system, the pedal feeling, namely a feeling of response to the depression of the brake pedal, is generated by the stroke simulator, and the stroke simulator is generally configured by a combination of elastic bodies, such as springs and rubber etc. In the stroke simulator, as a result of the brake fluid pressure generated by the operation of the brake pedal by the driver, based on a spring that is compressed via a piston, or on load-displacement characteristics of an elastic body, a relationship is determined between a stroke, which is an amount of operation of the brake pedal, and an input load, which is an operation force.

Therefore, in the stroke simulator, it is not possible to change once-determined characteristics and, in the brake device, it is only possible to control the brake fluid pressure. As a result, it is not possible to independently vary each of characteristics of the brake fluid pressure corresponding to the input load of the brake pedal and characteristics of the brake fluid pressure corresponding to the stroke of the brake pedal.

In light of the foregoing, it is an object of the present invention to provide a brake device that is capable of independently varying each of characteristics of brake fluid pressure corresponding to an operation amount of a brake operating member and characteristics of brake fluid pressure corresponding to an operation force of the brake operating member, by varying a relationship between the operation amount and the operation force of the brake operating member.

### Solution to Problem

In order to achieve the above-described object, a first aspect of the invention is characterized in that a brake device includes: an M/C that forms a driving hydraulic pressure chamber that drives a master piston by a supply and discharge of brake fluid, and also forms a reaction force chamber that is compressed or expanded in accordance with an operation of a brake operating member; an electric pressure adjustment portion that adjusts a driving hydraulic pressure of the driving hydraulic pressure chamber by supplying the brake fluid to the inside of the driving hydraulic pressure chamber or by discharging the brake fluid from the inside of the driving hydraulic pressure chamber; and a reaction force generating portion that generates a reaction force hydraulic pressure inside the reaction force chamber in accordance with an operation amount of the brake operating member. The brake device is characterized in that the brake device is provided with an adjustment mechanism which, by being adjusted by a driver and controlling the electric pressure adjustment portion and the reaction force generating portion, changes at least one of F-P characteristics, which are characteristics of a brake operation force F of the brake operating member and of a brake fluid pressure P output from the M/C, and St-P characteristics, which are characteristics of an operation amount St of the brake operating member and of the brake fluid pressure P, with respect to initial setting characteristics that are set in advance as the F-P characteristics and the St-P characteristics.

The adjustment mechanism that can be operated by the driver is provided in this way, and at least one of the F-P characteristics and the St-P characteristics are changed by controlling the driving hydraulic pressure chamber and the reaction force chamber based on the operation of the adjustment mechanism. In this manner, it is possible to adjust the braking characteristics in accordance with a requirement of the driver. Further, for example, by setting in advance a range over which the adjustment can be made by the operation of the adjustment mechanism to a range that takes into account the safety of the vehicle, it is possible for the driver to freely change the braking characteristics to a personal preference within that range. In this manner, it is possible to provide the driver with a comfortable and new driving environment.

A second aspect of the invention is characterized by including: storage means capable of saving a plurality of patterns for adjustment of at least one of the F-P characteristics and the St-P characteristics by the adjustment mechanism; and characteristics selection means for selecting a pattern from among the plurality of patterns saved in the storage means.

By providing the characteristics selection means and the storage means in this way, it is possible to save the plurality of patterns that accord with preferences of a plurality of drivers. In this manner, each of the drivers can change the characteristics according to his/her own personal preference in a single operation by operation of the characteristics selection means. In this case, for example, as in a third aspect, at a time of engine start up, from among the plurality of patterns saved in the storage means, a pattern selected by the characteristics selection means at the time of the engine start up can be selected.

A fourth aspect of the invention is characterized in that ID information for each of the driver and each of the plurality of patterns are saved in the storage means in a manner that the ID information for each driver is associated with corresponding one of the plurality of patterns. Further, the brake device includes: signal input means for inputting the ID information for each driver that is received from a portable device that outputs a signal including the ID information; and means for selecting, from the plurality of patterns, a pattern corresponding to the ID information input by the signal input means, in priority to the pattern over the pattern selected by the characteristics selection means.

In this way, by inputting the ID information for each of the drivers from a keyless portable device or an ID card or the like, and selecting the pattern corresponding to the ID information from among the plurality of saved patterns, it is possible to automatically set the characteristics that accord with the preferences of each of the drivers.

A fifth aspect of the present invention is characterized by including vehicle condition detection means for detecting a vehicle condition, the vehicle condition being at least one of a traveling environment and a traveling state of the vehicle, and is characterized in that the adjustment of the at least one of the F-P characteristics and the St-P characteristics is performed based on the vehicle condition detected by the vehicle condition detection means.

When the vehicle condition, such as a traveling environment that includes a road surface, etc. or a traveling state that includes a vehicle speed, etc., changes, if at least one of the F-P characteristics and the St-P characteristics are adjusted based on the vehicle condition, it is possible to perform characteristics adjustment in accordance with the vehicle condition. For example, as in a sixth aspect, it is possible to obtain navigation information as the traveling environment of the vehicle and to perform the adjustment of the at least one of the F-P characteristics and the St-P characteristics based on environment parameters shown in the navigation information. Further, as in a seventh aspect, a vehicle speed may be detected as the traveling state of the vehicle, and the adjustment of the at least one of the F-P characteristics and the St-P characteristics may be performed based on the vehicle speed.

An eighth aspect of the invention is characterized by including: time of emergency determination means for determining whether or not it is a time of emergency; and time of emergency characteristics setting means that, when it is determined by the time of emergency determination means that it is not the time of emergency, performs the adjustment of the F-P characteristics and the St-P characteristics based on the adjustment by the adjustment mechanism, and when it is determined that it is the time of emergency, performs the adjustment of the F-P characteristics and the St-P characteristics for the time of emergency that are set based on a vehicle condition, in priority to the adjustment by the adjustment mechanism.

In this way, when it is not the time of emergency, the preferences of the driver are prioritized, and when it is the time of emergency, the safety of the vehicle is prioritized in accordance with the demands from the vehicle side, over the preferences of the driver. In this manner, it is possible to secure the safety of the vehicle while also performing the characteristics adjustment in accordance with the driver preference.

A ninth aspect of the present invention is characterized by including: a brake fluid pressure control actuator provided between the M/C and a W/C; and control means for executing brake fluid pressure control in which the brake fluid pressure P output from the M/C is controlled using the brake fluid pressure control actuator and is transmitted to the W/C, and is characterized in that the control means corrects a control amount of the brake fluid pressure control in accordance with changes in the F-P characteristics and the St-P characteristics.

In this way, as measures on the downstream side of the brake device, sensitivity correction of the brake fluid pressure control is performed by correcting the control amount of the brake fluid pressure control. In this way, while performing the characteristics changes in accordance with the driver preference on the upstream side of the brake device, it is possible to perform the sensitivity correction of the brake fluid pressure control on the downstream side accordingly. For example, as in a tenth aspect, in the control means, as a correction of the control amount, the control means can perform correction in accordance with the changes in the F-P characteristics and the St-P characteristics with respect to at least one of a proportional term and a constant term that corrects a threshold value of the brake fluid pressure control.

Note that the numerals inside brackets of each of the above-described means indicate a corresponding relationship with specific means noted in embodiments to be explained later.

### BRIEF DESCRIPTION OF DRAWINGS

FIG. 1 is a circuit schematic view showing an overall configuration of a vehicle brake device 1 according to a first embodiment of the present invention.

FIG. 2 shows graphs illustrating various characteristics and characteristics of adjustment dials 14 and 15.

FIG. 3 is a circuit schematic view showing an overall configuration of the vehicle brake device 1 according to a second embodiment of the present invention.

FIG. 4 (a) and FIG. 4 (b) are, respectively, characteristic line charts of F-P characteristics and St-P characteristics according to vehicle conditions, of the brake device 1 according to a third embodiment of the present invention.

FIG. 5 is a flowchart showing, in detail, processing executed by a brake ECU 9 in the brake device 1 according to a fourth embodiment of the present invention.

FIG. 6 is a flowchart showing, in detail, processing executed in downstream measures.

### DESCRIPTION OF EMBODIMENTS

Hereinafter, embodiments of the present invention will be explained based on the drawings. Note that, for each of the embodiments explained hereinafter, where portions are the same as or correspond to each other, the same reference numeral is allocated in the explanation.

### First Embodiment

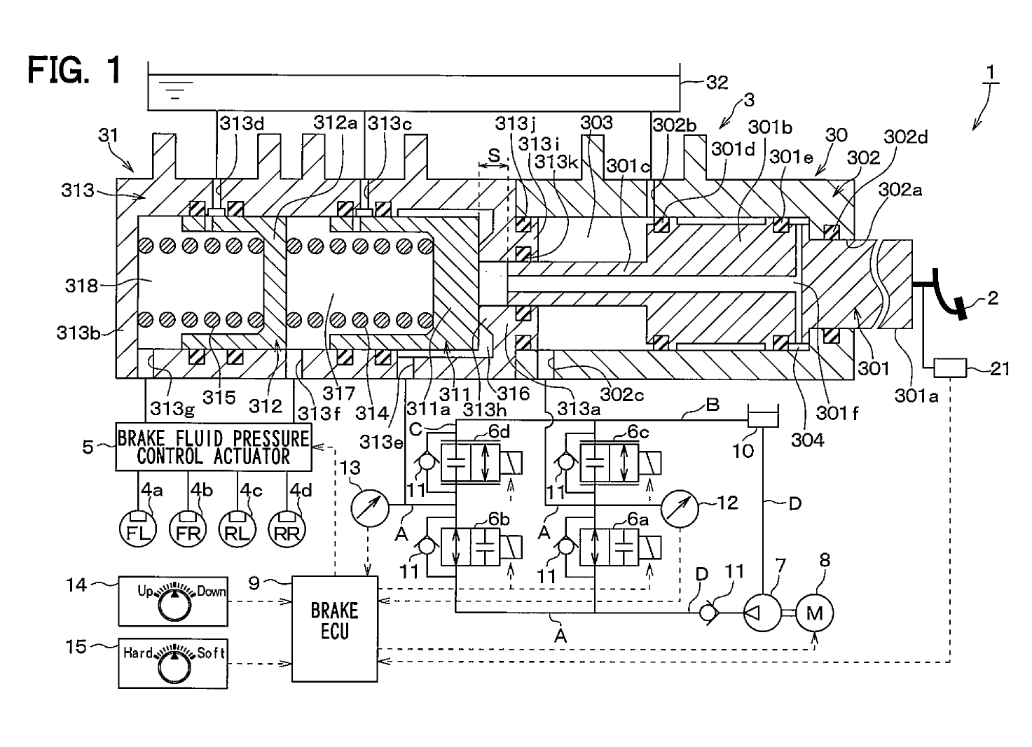

A first embodiment of the present invention will be explained. FIG. 1 shows an overall configuration of a vehicle brake device 1 to which a first embodiment of the present invention is applied. Hereinafter, the brake device 1 of the present embodiment will be explained with reference to FIG. 1.

As shown in FIG. 1, the brake device 1 is provided with a brake pedal 2, an M/C 3, W/Cs 4a to 4d, a brake fluid pressure control actuator 5, first to fourth control valves 6a to 6d, a pump 7, a motor 8 and a brake ECU 9 etc.

When the brake pedal 2 is depressed by a driver, the brake pedal 2 applies a pressing force to an input piston 301 provided inside the M/C 3. An operation amount of the brake pedal 2 is detected by an operation amount sensor 21. The operation amount sensor 21 is configured by a stroke sensor and a depression force sensor etc., for example, and a detection signal of the operation amount sensor 21 is supplied to the brake ECU 9 so that the brake ECU 9 can ascertain the operation amount of the brake pedal 2. Note that here, the brake pedal 2 is given as an example of a brake operating member, but a brake lever or the like can also be adopted.

The M/C 3 is configured by an input portion 30 and an output portion 31, and a master reservoir 32. The input portion 30 is provided with the input piston 301 that is moved in accordance with the depression of the brake pedal 2, and the output portion 31 is provided with M/C pistons 311 and 312 that correspond to output pistons and that are moved when a service brake force is generated.

The input portion 30 is provided with the input piston 301 that is urged in accordance with the depression of the brake pedal 2, and with a cylinder portion 302 that forms a space that stores brake fluid at the same time that the input piston is caused to slidingly move.

The input piston 301 is configured to have a pressure receiving portion 301a, a sliding portion 301b and a pressing portion 301c. The pressure receiving portion 301a is a portion to which the depression force of the brake pedal 2 is input, and is inserted inside an opening 302a that is provided on one end of the cylinder portion 302. The diameter of the sliding portion 301b is larger than the pressure receiving portion 301a, and has the same dimensions as or is a slightly smaller diameter than an inner diameter of the cylinder portion 302. Seal members 301d and 301e, which are configured by O rings and the like, are provided around the outer peripheral surface of the sliding portion 301b and function as a seal between the sliding portion 301b and the cylinder portion 302. The pressing portion 301c has a smaller diameter than the sliding portion 301b and has a configuration in which it protrudes in an axial direction toward the output portion 31 side from the sliding portion 301b. A leading end of the pressing portion 301c is disposed so as to be separated from the M/C piston 311 by a gap S.

Further, a communication passage 301f is formed inside the pressing portion 301c and the sliding portion 301b. The communication passage 301f extends from the leading end of the pressing portion 301c further to the brake pedal 2 side than the seal member 301e on the outer peripheral surface of the sliding portion 301b. Due to the communication passage 301f, brake fluid inside a space formed by the gap S between the leading end of the pressing portion 301c and the M/C piston 311 can flow.

While securing the seal between the outer peripheral surface of the sliding portion 301b and the inner peripheral surface of the cylinder portion 302 using the seal members 301d and 301e, the cylinder portion 302 causes the input piston 301 to slide in the axial direction. The opening 302a, into which the pressure receiving portion 301a is inserted, a communication passage 302b that communicatively connects the master reservoir 32, which is at atmospheric pressure, and a communication passage 302c that communicatively connects a hydraulic circuit configured by the control valves 6a to 6d and the pump 7 etc., are formed in the cylinder portion 302. A seal member 302d is provided on the inner wall surface of the opening 302a and forms a seal between the opening 302a of the cylinder portion 302 and the outer peripheral surface of the pressure receiving portion 301a.

The input portion 30 is configured in this manner. In the input portion 30 that is configured in this manner, as the input piston 301 is disposed inside the cylinder portion 302, a reaction force chamber 303 is formed further to the side of the output portion 31 than the sliding portion 301b inside in the cylinder 302. The reaction force chamber 303 is connected to the hydraulic circuit that is configured by the control valves 6a to 6d and the pump 7 etc., via the communication passage 302c.

Furthermore, at a position further to the brake pedal 2 side than the seal member 301e inside the cylinder portion 302, a back chamber 304 is formed by the outer surface of the sliding portion 301b and a section further to the brake pedal 2 side than the sliding portion 301b. The back chamber 304 is communicatively connected, via the communication passage 301f formed inside the pressing portion 301c and the sliding portion 301b, to the space formed by the gap S between the leading end of the pressing portion 301c and the M/C piston 311. Then, based on the movement of the input piston 301, an area of a difference between the inner diameter of the cylinder portion 302 and the outer diameter of the pressure receiving portion 301a is caused to match an area of the leading end of the pressing portion 301c, so that displacement amounts of a displacement in a capacity of the space formed by the gap S between the leading end of the pressing portion 301c and the M/C piston 311 and a displacement in a capacity of the back chamber 304 are equal to each other. As a result, even when the input piston 301 moves in either direction in the axial direction inside the cylinder portion 302, it is possible to avoid a reaction force from being generated.

Note that, in a state before the brake pedal 2 is depressed, the communication passage 302b is disposed to the side further away from the brake pedal 2 than the seal member 301d, but is disposed to be immediately positioned more to the brake pedal 2 side than the seal member 301d when the input piston 301 is moved as a result of depressing the brake pedal 2. Thus, when the brake pedal 2 is depressed, the inside of the reaction force chamber 303 and the master reservoir 32 are shut off, and the brake fluid pressure inside the reaction force chamber 303 is increased.

The output portion 31 is configured to have the M/C pistons 311 and 312, a cylinder portion 313 and return springs 314 and 315.

The M/C pistons 311 and 312 are disposed coaxially inside the cylinder portion 313 such that the M/C piston 311 is further to the side of the input piston 301 than the M/C piston 312, where the M/C piston 311 is a primary piston and the M/C piston 312 is a secondary piston. The M/C pistons 311 and 312 each have a bottomed cylindrical shaped and are disposed inside the cylinder portion 313 such that bottom portions 311a and 312a are facing toward the input piston 301. In this way, as well as forming a driving hydraulic pressure chamber 316 between the bottom portion of the M/C piston 311 and a one end surface 313a of the cylinder portion 313, a primary chamber 317 is formed between the M/C piston 311 and the M/C piston 312 and a secondary chamber 318 is formed between the M/C piston 312 and another end of the cylinder portion 313.

The cylinder portion 313 is a hollow cylindrical shape having both the end surfaces 313a and 313b, and the M/C pistons 311 and 312 are housed in the hollow interior thereof.

Communication passages 313c to 313g are formed in the outer peripheral surface of the cylinder portion 313. When the M/C pistons 311 and 312 are positioned in an initial position that is a state in which the service brake force is not generated, the communication passages 313c and 313d communicatively connect the master reservoir 32 that is at atmospheric pressure with the primary chamber 317 and the secondary chamber 318, respectively. When the M/C pistons 311 and 312 are moved from the initial position, the communication passages 313c and 313d are shut off by the outer peripheral surface of the M/C pistons 311 and 312. The communication passage 313e communicatively connects the hydraulic circuit configured by the control valves 6a to 6d and the pump 7 etc. with the driving hydraulic pressure chamber 316. The communication passages 313f and 313g communicatively connect the primary chamber 317 and the secondary chamber 318 with a first pipeline system and a second pipeline system in a hydraulic brake circuit.

Further, the inner diameter of the cylinder portion 313 is expanded on the bottom portion side of the M/C piston 311. In addition, a protruding portion 313h is provided that protrudes from the one end surface 313a of the cylinder portion 313 toward the M/C piston 311 side, and a gap is thereby provided between the one end surface 313a of the cylinder portion 313 and the bottom portion of the M/C piston 311. The driving hydraulic pressure chamber 316 is configured by the expanded section of the inner diameter of the cylinder portion 313 and the gap between the one end surface 313a of the cylinder portion 313 and the bottom portion of the M/C piston 311.

It should be noted that although the cylinder portion 313 is illustrated as being a single member, the cylinder portion 313 is configured by combining and integrating a plurality of members.

The returns springs 314 and 315 are respectively disposed between the M/C piston 311 and the M/C piston 312, and between the M/C piston 312 and the other end surface 313b of the cylinder portion 313. At the same time as generating a reaction force when the M/C piston 312 is urged to the left as seen in the drawings, the return springs 314 and 315 fulfil a role to return the M/C pistons 311 and 312 to the side of the input piston 301 when the service brake force is not generated.

The output portion 31 is configured by the above-described type of structure. Then, the M/C 3 is configured by integrating the input portion 30 and the output portion 31 by connecting leading end portions of both the cylinders 302 and 313, specifically, by fitting an insertion portion 313i, which is on the opposite side to the protruding portion 313h on the one end surface 313a of the cylinder portion 313, into the cylinder portion 302. Note that a seal member 313j that is configured by an O ring or the like is provided on the outer peripheral side of the insertion portion 313i, and a sealing performance with the cylinder portion 302 is secured. Further, a seal member 313k that is configured by an O ring or the like is also provided on the inner peripheral side of the insertion portion 313i, and the sealing performance between the reaction force chamber 303 and the bottom portion side of the M/C piston 311 is secured.

The W/Cs 4a to 4d are communicatively connected to the primary chamber 317 or the secondary chamber 318, respectively, via the brake fluid pressure control actuator 5. For example, in the case of front and rear pipelines, the W/Cs 4a and 4b of left and right front wheels FL and FR are connected to the primary chamber 317 via the first pipeline system, and the W/Cs 4c and 4d of left and right rear wheels RL and RR are connected to the secondary chamber 318 via the second pipeline system. Then, when a brake fluid pressure (an M/C pressure) of the same pressure is generated with respect to the primary chamber 317 and the secondary chamber 318 of the M/C 3, the pressure is transmitted to each of the W/Cs 4a to 4d via the brake fluid pressure control actuator 5 and the W/C pressure is thus generated, and a braking force is generated in each of the vehicle wheels FL to RR.

The brake fluid pressure control actuator 5 is configured by a brake fluid pressure circuit for adjusting the W/C pressure. Specifically, the brake fluid pressure control actuator 5 forms a plurality of pipes that perform control of the brake fluid pressure in a metal housing, and various electromagnetic valves and a pumps are connected to the pipes formed in the housing. At the same time, a pump drive motor is fixed to the housing, thus configuring a brake fluid pressure circuit between the M/C 3 and the W/Cs 4a to 4d. Then, by driving the various electromagnetic valves and operating the pump by driving the motor etc., the brake ECU 9 controls the brake fluid pressure inside the brake fluid pressure circuit and thus adjusts the W/C pressure. Note that the structure of the brake fluid pressure control actuator 5 is a known structure and a detailed explanation thereof is therefore omitted here.

The first to fourth control valves 6a to 6d correspond to valve devices, and are configured as electromagnetic valves that can switch between a communication state and a shut off state. The first and second control valves 6a and 6b are normally open types and the third and fourth control valves 6c and 6d are normally closed types. Of these, the second and fourth control valves 6b and 6d configure pressure adjustment control valves, and the first and third control valves 6a and 6c configure reaction force control valves. The pump 7 performs a brake fluid intake and discharge operation, based on the driving of the motor 8. Of the above, the first and third control valves 6a and 6c, the pump 7 and the motor 8 configure a reaction force generation portion that generates a reaction force hydraulic pressure in accordance with the operation amount of the brake pedal 2, by compressing or expanding the reaction force chamber 303 in response to the operation of the brake pedal 2. Further, the second and fourth control valves 6b and 6d, the pump 7 and the motor 8 configure an electric pressure adjustment portion that adjusts the driving hydraulic pressure inside the driving hydraulic pressure chamber 316 by supplying the brake fluid to the driving hydraulic pressure chamber 316 or discharging the brake fluid from the driving hydraulic pressure chamber 316.

Specifically, the first to fourth control valves 6a to 6d and the pump 7 configure a hydraulic circuit that is provided between the reaction force chamber 303 of the input portion 30 and the driving hydraulic pressure chamber 316 of the output portion 31. A section between the reaction force chamber 303 and the driving hydraulic pressure chamber 316 is connected by a conduit A that corresponds to an inter-chamber brake fluid path, and the normally open first and second control valves 6a and 6b are provided in the conduit A. Further, a section in the conduit A between the reaction force chamber 303 and the first control valve 6a and a section between the reaction force chamber 303 and an atmospheric pressure reservoir 10 are connected by a conduit B, and the normally closed third control valve 6c is provided in the conduit B. Further, a section in the conduit A between the driving hydraulic pressure chamber 316 and the second control valve 6b is connected by a conduit C, and the normally closed fourth control valve 6d is provided in the conduit C. In addition, the atmospheric pressure reservoir 10 is connected to a section in the conduit A between the first control valve 6a and the second control valve 6b by a conduit D, and the pump 7 is provided in the conduit D. Note that a check valve 11 is provided in parallel to each of the control valves 6a to 6d and on a discharge outlet side of the pump 7, and a configuration is adopted in which a flow of the brake fluid from the driving hydraulic pressure chamber 316 side to the reaction force chamber 303 or the atmospheric pressure reservoir 10 when the valve is closed, or an application of high pressure to the discharge outlet of the pump 7 do not occur.

In addition, a first pressure sensor 12 is provided in a portion of the conduit A further to the reaction force chamber 303 side than the first control valve 6a, and a second pressure sensor 13 is provided in a portion of the conduit A further to the driving hydraulic pressure chamber 316 side than the second control valve 6b. The reaction force hydraulic pressure inside the reaction force chamber 303 and the driving hydraulic pressure inside the driving hydraulic pressure chamber 316 are monitored by the first and second pressure sensors 12 and 13, and detection signals of the first and second pressure sensors 12 and 13 are input to the brake ECU 9. Then, based on the reaction force hydraulic pressure inside the reaction force chamber 303 and the driving hydraulic pressure inside the driving hydraulic pressure chamber 316, the brake ECU 9 controls the first to fourth control valves 6a to 6d, and at the same time, drives the motor 8 and operates the pump 7, thus performing operations to generate a reaction force to the depression of the brake pedal 2 at a time of regenerative braking and to adjust the M/C pressure etc.

The brake device 1 according to the present embodiment is configured in the manner described above. Next, operations of the brake device 1 configured in this manner will be explained, with reference to a case of normal operation and a case of abnormal operation (a power failure).

(1) Operations at Time of Normality

During normal operation, namely, when the brake ECU 9 etc. is not malfunctioning and can perform driving of the control valves 6a to 6d and the motor 8 etc. in a normal manner, based on detection signals of the operation amount sensor 21 and the first and second pressure sensors 12 and 13, the operation amount of the brake pedal 2 is monitored, and at the same time, the brake pressure inside the reaction force chamber 303 and the driving hydraulic pressure chamber 316 is monitored.

In addition, at the same time as switching the second control valve 6b to the shut off state, the motor 8 is driven and the pump 7 is operated. Thus, until the leading end of the pressing portion 301c of the input piston 301 comes into contact with the M/C piston 311 in accordance with the depression of the brake pedal 2, the M/C pressure is not generated, by keeping the second control valve 6b in the shut off state. In other words, in regenerative cooperation control, it is possible to keep the input piston 301 from contacting the M/C piston 311 that is the output piston until a maximum regenerative braking force that can be generated is generated, and it is possible to achieve a maximum amount of regeneration efficiency.

Then, as the first control valve 6a is in the communication state, the brake fluid is introduced into the reaction force chamber 303 by the intake and discharge operation of the pump 7, the reaction force hydraulic pressure inside the reaction force chamber 303 increases, and a pedal reaction force is applied to the brake pedal 2 via the input piston 301. At that time, based on the monitor results of the operation amount sensor 21 and the first pressure sensor 12, the brake fluid pressure inside the reaction force chamber 303 is adjusted by the third control valve 6c such that the pedal reaction force is generated that corresponds to the operation amount of the brake pedal 2. In other words, by adjusting an amount of current conducted to a solenoid of the third control valve 6c, a differential pressure between the upstream and the downstream of the third control valve 6c is controlled in a linear manner, and it is thus possible to apply the pedal reaction force that corresponds to the operation amount of the brake pedal 2.

After that, when the operation amount of the brake pedal 2 becomes larger, and a maximum amount is reached that can be generated by the regenerative braking, the second control valve 6b is caused to be in the communication state. In this way, the brake fluid is also introduced into the driving hydraulic pressure chamber 316, the brake fluid pressure inside the driving hydraulic pressure chamber 316 increases, the M/C pistons 311 and 312 are pressed to the left as seen in the drawings, and the M/C pressure is generated. Further, the fourth control valve 6d is operated at the same time, and the brake fluid pressure inside the driving hydraulic pressure chamber 316 is adjusted based on the monitor results of the operation amount sensor 21 and the second pressure sensor 13. In this way, it is possible to generate, of the braking force generated corresponding to the operation amount of the brake pedal 2, a portion excluding the regenerative brake portion.

When the M/C pressure is generated in this manner, this pressure is transmitted to each of the W/Cs 4a to 4d via the brake fluid pressure control actuator 5. In this way, it is possible to generate a desired braking force.

(2) Operations at Time of Abnormality

At a time of abnormality, namely, when the brake ECU 9 etc. is malfunctioning and cannot perform driving of the control valves 6a to 6d and the motor 8 etc. in a normal manner, it is not possible to operate the first to fourth control valves 6a to 6d and the motor 8, and the first to fourth control valves 6a to 6d remain in the positions shown in the drawings.

In this state, when the brake pedal 2 is depressed, the input piston 301 is moved to the left as seen in the drawings, and as a result, the brake fluid inside the reaction force chamber 303 is caused to pass through the conduit A and move to inside the driving hydraulic pressure chamber 316. In other words, since the first and second control valves 6a and 6b are both in the communication state and the third and fourth control valves 6c and 6d are both in the shut off state, an amount corresponding to the amount of brake fluid pressed out from the reaction force chamber 303 is introduced into the driving hydraulic pressure chamber 316.

In this manner, due to the brake fluid pressure inside the driving hydraulic pressure chamber 316, the M/C pistons 311 and 312 are pressed to the left as seen in the drawings, and the M/C pressure is generated. When the M/C pressure is generated in this way, the M/C pressure is transmitted to each of the W/Cs 4a to 4d via the brake fluid pressure control actuator 5. In this manner, it is possible to generate a desired braking force. Thus, even if there is an abnormality, it is possible to generate the braking force before the input piston 301 comes into contact with the M/C piston 311 that is the output piston, and even if the gap S is provided between the input piston 301 and the M/C piston 311, it is possible to prevent an invalid stroke.

In the brake device 1 of the present embodiment that has this type of configuration and performs this type of operation, by changing the relationship between the stroke and the input load of the brake pedal 2, the characteristics of the brake fluid pressure with respect to the input load of the brake pedal 2, and the characteristics of the brake fluid pressure with respect to the stroke of the brake pedal 2 can each be and appropriately changed independently from each other. Specifically, in the brake device 1, as an adjustment mechanism, adjustment dials 14 and 15 are provided in a position in which they can be operated by the driver in a driving seat, such as in an installment panel etc., and a signal corresponding to operation of the adjustment dials 14 and 15 is input to the brake ECU 9. Based on the operation of the adjustment dials 14 and 15, on the upstream side of the brake device 1, by controlling the third and fourth control valves 6c and 6d etc. of the valve devices, it is possible to adjust various characteristics. Note that, here, of the hydraulic circuit that configures the brake device 1, the upstream side refers to from the brake pedal 2 to the M/C 3 that includes the first to fourth control valves 6a to 6d that configure the valve devices, and the brake fluid pressure control actuator 5 and the W/Cs 4a to 4d are the downstream side.

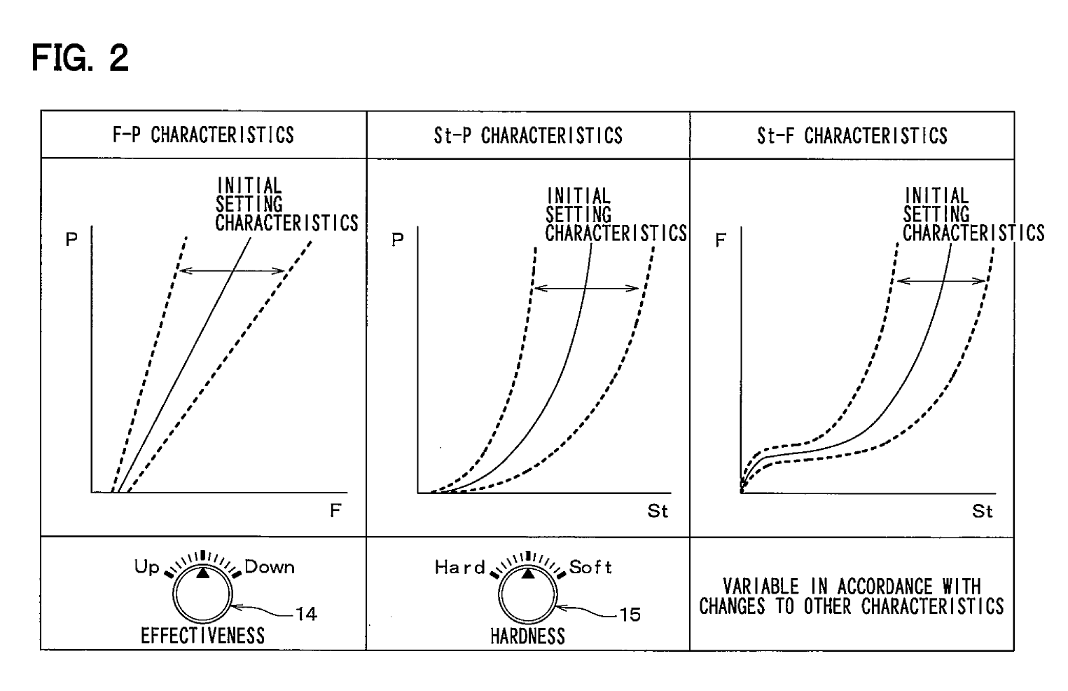

FIG. 2 shows graphs illustrating various characteristics and the characteristics of the adjustment dials 14 and 15. It is assumed that characteristics of an input load F and a brake fluid pressure P output from the M/C 3 (hereinafter referred to as F-P characteristics), characteristics of a stroke St of the brake pedal 2 and of the input load F (hereinafter referred to as St-F characteristics), and characteristics of the brake fluid pressure P with respect to the stroke St (hereinafter referred to as St-P characteristics) are initial setting characteristics illustrated by solid lines, for example, in FIG. 2. For example, for the F-P characteristics, when the input load F is generated that is equal to or more than an amount of play of the brake pedal 2, a relationship is obtained in which the brake fluid pressure P increases proportionally with respect to the generated input load F. Further, for the St-P characteristics, when the stroke St is generated that is equal to or more than the amount of play, a relationship is obtained in which the brake fluid pressure P increases curvilinearly with respect to the generated stroke St. In addition, for the St-F characteristics, a relationship is obtained in which, in an area in which the stroke St is small, the input load F does not significantly increase, but when the stroke St gets larger, the input load F rapidly increases.

With respect to these types of relationships, the adjustment dial 14 varies the F-P characteristics shown in FIG. 2. Namely, the adjustment dial 14 performs adjustment with respect to the initial setting characteristics, to increase a brake effectiveness (a correction servo amount) such that the brake fluid pressure P becomes larger even when the input load F is small, or, in contrast, to decrease the brake effectiveness (refer to broken lines in FIG. 2). In addition, the adjustment dial 15 varies the St-P characteristics shown in FIG. 2. Namely, the adjustment dial 15 performs adjustment with respect to the initial setting characteristics, to harden the hardness of the brakes (a correction reaction amount) such that the brake fluid pressure P becomes larger even when the stroke St is small, or, in contrast, to soften the hardness of the brakes (refer to broken lines in FIG. 2).

Further, the St-F characteristics are also varied, but the St-F characteristics are varied in accordance with the changes to the F-P characteristics and the St-P characteristics. Note that, if one of the F-P characteristics, the St-P characteristics or the St-F characteristics are fixed, the other two characteristics cannot be adjusted independently from each other. Therefore, by making all of the three characteristics variable, it is possible to independently adjust a desired two of the characteristics.

Specifically, in the brake device 1 of the present embodiment, when the F-P characteristics and the St-P characteristics are changed, this is performed by controlling the reaction force generation portion and the electric pressure adjustment portion. For example, when the F-P characteristics are changed, the third control valve 6c and the fourth control valve 6d are controlled and a pressure differential generated by these valves is controlled. In this way, at the same time that the input load F is adjusted by adjusting the reaction force hydraulic pressure generated inside the reaction force chamber 303, the brake fluid pressure P is adjusted by adjusting the driving hydraulic pressure generated inside the driving hydraulic pressure chamber 316, and the F-P characteristics are changed. In comparison to when the initial setting characteristics are obtained, for example, when a ratio of an increase amount in a differential pressure indication value of the fourth control valve 6d with respect to an increase amount in a differential pressure indication value of the third control valve 6c corresponding to the depression of the brake pedal 2 is smaller, the brake effectiveness is reduced, and when the ratio is larger, the brake effectiveness is increased.

On the other hand, when the St-P characteristics are changed, the fourth control valve 6d is controlled, for example, and the differential pressure generated by the fourth control valve 6d is controlled. The brake fluid pressure P is adjusted by adjusting the driving hydraulic pressure generated inside the driving hydraulic pressure chamber 316 corresponding to the stroke St, and the St-P characteristics are changed. In comparison to when the initial setting characteristics are obtained, for example, when a ratio of an increase amount in a differential pressure indication value of the fourth control valve 6d with respect to the stroke St of the brake pedal 2 is larger, the hardness of the brakes is hardened, and when the ratio is smaller, the hardness of the brakes is softened.

It should be noted that the St-F characteristics are changed in accordance with the changes in the F-P characteristics and the St-P characteristics, but an adjustment dial for the St-F characteristics may be provided in place of either the F-P characteristics or the St-P characteristics, and the St-F characteristics may then be independently varied by the driver. When the St-F characteristics are changed, for example, the third control valve 6c is adjusted and, in comparison to the initial setting characteristics, if the differential pressure indication value of the third control valve 6c is larger with respect to the stroke St of the brake pedal 2, it is possible to change the characteristics to a side in which the input load F becomes larger with respect to the stroke St (indicated by an arrow to the left side in FIG. 2). In contrast, if the differential pressure indication value of the third control valve 6c is smaller with respect to the stroke St, it is possible to change the characteristics to a side in which the input load F becomes smaller with respect to the stroke St (indicated by an arrow to the right side in FIG. 2).

In this way, by providing the adjustment dials 14 and 15 in a position that can be operated by the driver, the F-P characteristics, the St-P characteristics and the St-F characteristics are changed based on the operation of the adjustment dials 14 and 15. In this manner, it becomes possible to adjust the braking characteristics in accordance with a requirement of the driver. Then, by setting in advance a range over which the adjustment can be made by operation of the adjustment dials 14 and 15 to a range that takes into account the safety of the vehicle, it is possible for the driver to freely change the braking characteristics to a personal preference within the set range. In this manner, it is possible to provide the driver with a comfortable and new driving environment.

### Second Embodiment

A second embodiment of the present invention will be explained. In contrast to the first embodiment, the present embodiment allows adjustment of characteristics in accordance with preferences of a plurality of drivers. In other respects, the present embodiment is the same as the first embodiment, and therefore, only portions that are different to the first embodiment will be explained.

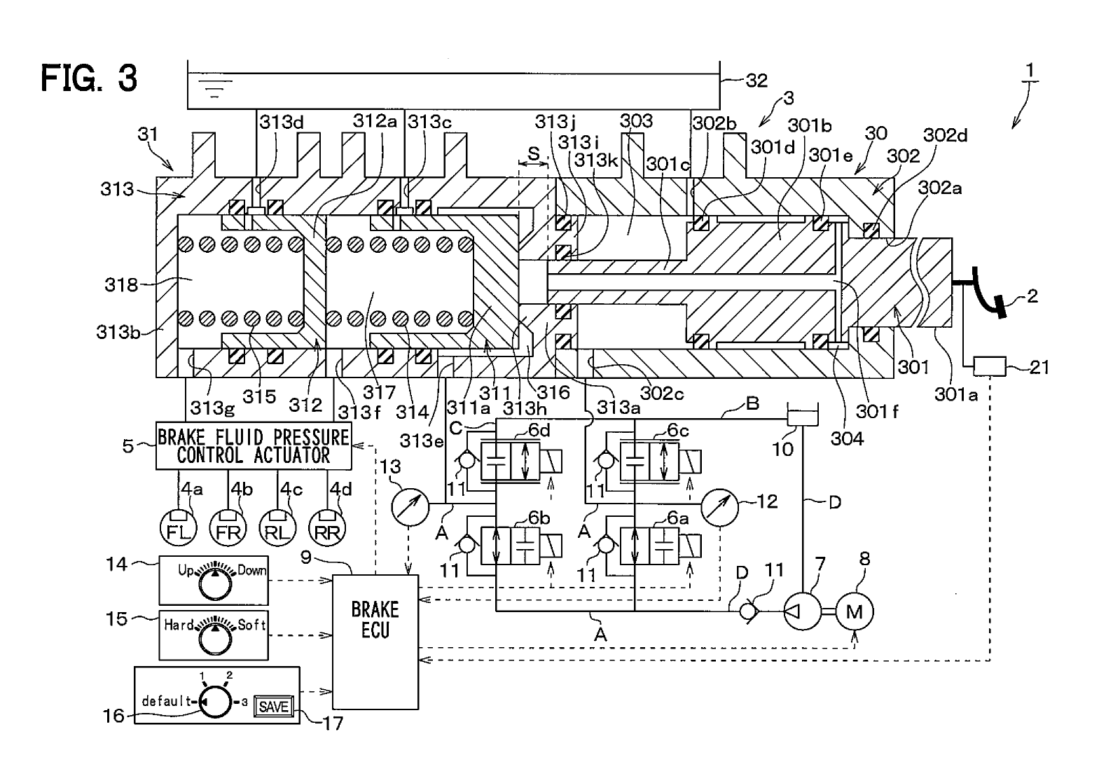

FIG. 3 shows an overall configuration of the brake device 1 according to the present embodiment. As shown in FIG. 3, in the present embodiment, in addition to signals to the brake ECU 9 that accord with the operation of the adjustment dials 14 and 15, a configuration is adopted in which signals are input that accord with operation of a characteristics selection dial 16 that is characteristics selection means, and a save switch 17 for executing a save instruction. The characteristics selection dial 16 is a dial for selecting a default dial position that selects the initial setting characteristics, and dial positions 1 to 3 that are set to patterns according to each of driver characteristics. If the default dial is selected by moving the characteristics selection dial 16, the F-P characteristics, the St-P characteristics and the St-F characteristics are set to the initial setting characteristics, and if one of the dials 1 to 3 is selected, characteristics of the patterns according to each of driver preferences are set. Further, the save switch 17 is a switch that instructs the saving of the various characteristics adjusted by the respective dials 1 to 3 in storage means, such as a memory etc., of the brake ECU 9.

For example, after a first driver changes various characteristics by operating the adjustment dials 14 and 15, when the first driver wishes to save those characteristics, the first driver moves the characteristics selection dial 16 to the dial position 1 and also presses the save switch 17. In this manner, the characteristics at that time are saved in the brake ECU 9 as characteristics of the dial position 1. By performing this type of operation in advance, after that, the first driver can set the characteristics according to the first driver's preferences by a single operation, simply by setting the characteristics selection dial 16 to the dial position 1. Further, when it is wished to set the characteristics to the personal preferences of a second driver who is different to the first driver, after adjusting the characteristics to the personal preferences by operating the adjustment dials 14 and 15, the second driver moves the characteristics selection dial 16 to the dial position 2 and further presses the save switch 17. In this manner, it is possible to save the characteristics of the second driver's preferences in the brake ECU 9, and the second driver can also set the characteristics according to the second driver's preferences by one operation, simply by setting the characteristics selection dial 16 to the dial position 2.

By providing the characteristics selection dial 16 and the save switch 17 in this way, it is possible to save in advance the plurality of patterns of characteristics that accord with the plurality of drivers' preferences. In this manner, each of the drivers can vary the characteristics according to their own personal preferences by a single dial operation. When the plurality of patterns of the characteristics can be performed in this way, at a time of engine start-up, the F-P characteristics and the St-P characteristics can be matched to the characteristics of the position selected using the characteristics selection dial 16 at the time of the engine start-up, for example.

### Third Embodiment

A third embodiment of the present invention will be explained. In contrast to the first embodiment, the present embodiment allows adjustment of characteristics in accordance with vehicle conditions. In other respects, the present embodiment is the same as the first embodiment, and therefore, only portions that are different to the first embodiment will be explained.

When the vehicle conditions change, desirable characteristics depending on that state also change, and it is therefore desirable to perform adjustment of characteristics in response to changes in the vehicle conditions. The vehicle conditions include, for example, a traveling state, such as a traveling environment including road conditions etc., or a traveling speed of the vehicle (a vehicle speed) etc. These vehicle conditions are detected and various characteristics are changed based on the vehicle conditions.

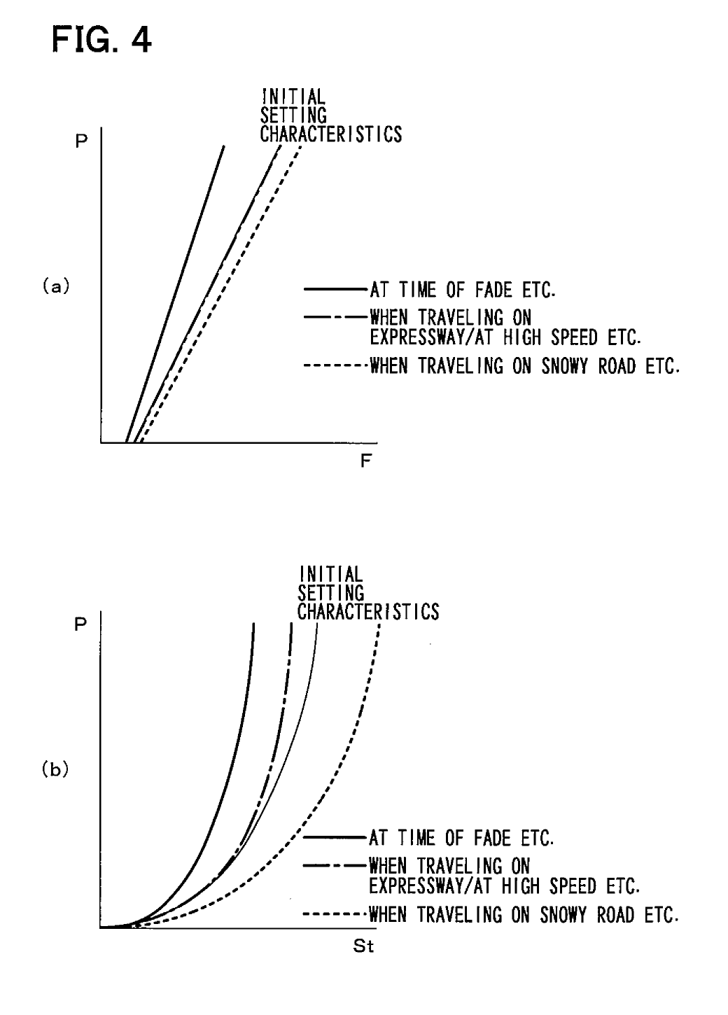

FIG. 4 (a) and FIG. 4 (b) are characteristic line charts of F-P characteristics and St-P characteristics in response to vehicle conditions, of the brake device 1 according to the present embodiment.

For example, when fade occurs, rigidity of the brake pedal 2 is increased in comparison to a time of normal operation, such that a rise of the brake fluid pressure P with respect to the stroke St and the input load F of the brake pedal 2 is larger and the brake effectiveness is improved. If this is done, the driver can firmly depress the brake pedal 2, and, as the brake effectiveness is improved even when fade occurs, a sense of reassurance can be conveyed to the driver.

Further, when the vehicle is traveling at high speed, or when it is traveling on an expressway, when braking from a moderate to high deceleration G, the rigidity of the brake pedal 2 is increased and the brake effectiveness is the same as normal, or is varied as necessary. In this way, the when there is a high possibility of high speed traveling, such as traveling at high speed or traveling on an expressway, the driver can firmly depress the brake pedal 2 while the brake effectiveness is not excessive, and a sense of reassurance can be conveyed to the driver.

Additionally, when traveling on a low μ road that has a low friction coefficient μ, such as when traveling in snow, it is easy for the wheels to lock, and thus it is preferable to set easy-to-handle characteristics having good controllability, by imparting a certain degree of length to the stroke St of the brake pedal 2. Thus, the rise of the brake fluid pressure P with respect to the stroke St and the input load F of the brake pedal 2 is delayed.

In this way, it is possible to vary the F-P characteristics and the St-P characteristics in response to vehicle conditions. It should be noted that the vehicle conditions can be detected by a known method, based on information from various sensors and other ECUs that correspond to vehicle condition detection means. For example, it is possible to detect whether or not fade is occurring from a relationship between the brake fluid pressure P being generated and the deceleration. Further, when traveling on the expressway or when traveling in snow, it is possible to perform verification using navigation information from a navigation device that indicates environment parameters, such as road information (road classification indicating a general road, an expressway, a mountain road, a sloping road etc.), a region (the prefecture, an urban area, a district etc.), and weather information etc. In addition, when traveling at high speed, it is possible to perform detection based on an estimated speed calculated from detection signals of wheel speed sensors, or on information from a meter ECU. Further, when determining whether or not the vehicle is traveling on a snowy road, or a sandy road, a dirt road etc., based on wheel speed information obtained from the vehicle speed and from the wheel speed sensors, it is possible to calculate a slip amount or slip ratio expressed by a deviation between an estimated vehicle body speed and the wheel speed, and to perform detection based on a magnitude of the slip amount or the slip ratio.

Note that, when the vehicle speed is high, it is also possible to set characteristics that are the same as those at a time of fade occurrence. Further, when the vehicle speed is high, two setting patterns may be prepared such that, in addition to the above-described characteristics, the same characteristics as those at the time of fade occurrence may also be set, and the settings may be varied in accordance with the speed, such that the characteristics that are the same as those at the time of fade occurrence are set when braking at a low deceleration G, and the above-described characteristics are set when braking at a moderate to high deceleration G.

### Fourth Embodiment

A fourth embodiment of the present invention will be explained. In the present embodiment, in contrast to the first to third embodiments, control is performed on the downstream side, namely, the brake fluid pressure control by the brake fluid pressure control actuator 5 is also adjusted. In other respects, the present embodiment is the same as the first to third embodiments, and therefore, only portions that are different to the first to third embodiments will be explained.

From the adjustment of the characteristics in accordance with the driver preference on the upstream side of the brake device 1, as illustrated in the above-described first to third embodiments, in the present embodiment, control is performed on the downstream side of the brake device 1 in accordance with the adjustment of the characteristics on the upstream side. Further, in an emergency, it is necessary to prioritize vehicle safety that accords with demands from the vehicle side over the preferences of the driver. In this case, it is preferable to adjust the characteristics on the downstream side in accordance with the vehicle conditions, irrespective of the adjustment of the characteristics by the driver on the upstream side of the brake device 1. Therefore, while matching the preferences of the driver on the upstream side of the brake device 1, control is performed on the downstream side that gives priority to the vehicle safety, in accordance with the vehicle conditions.

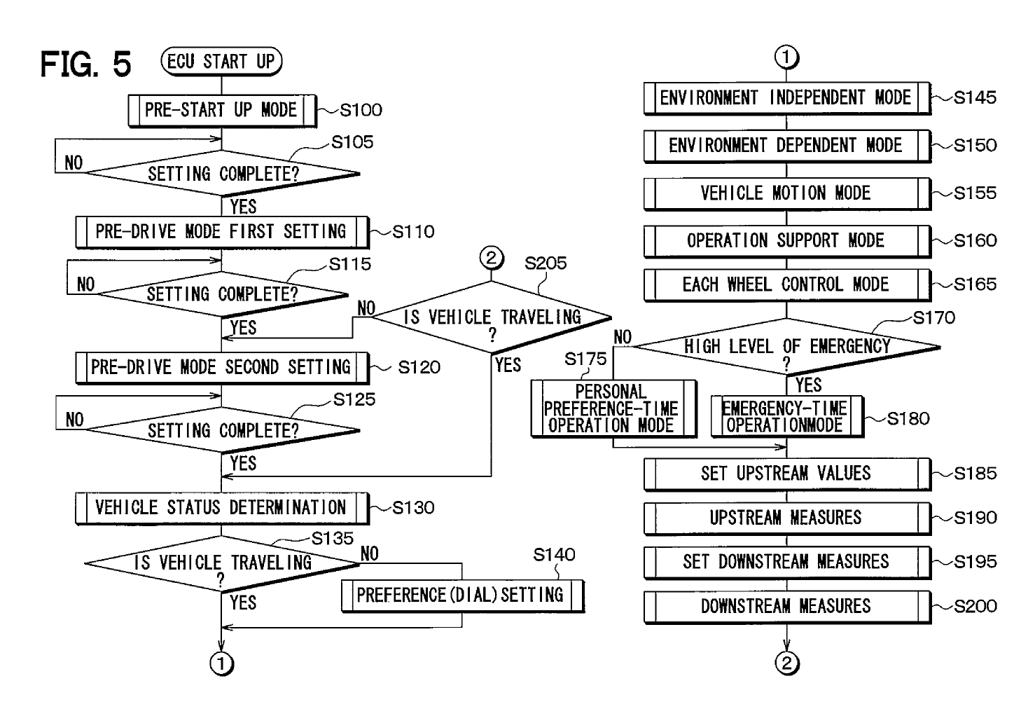

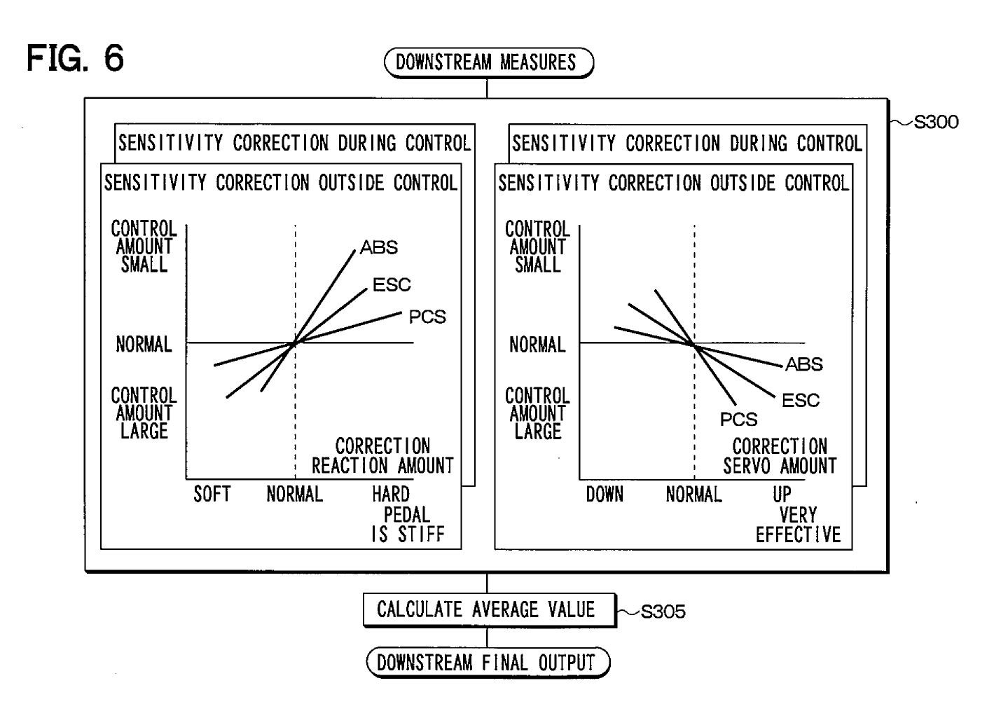

FIG. 5 is a flowchart showing, in detail, processing executed by the brake ECU 9, which corresponds to control means, in the brake device 1 according to the present embodiment. The processing executed by the brake ECU 9 to control the upstream side and the downstream side of the brake device 1 will be explained with reference to FIG. 5 and to FIG. 6 that will be described later. Note that, even when the brake ECU 9 is in a state before start up, the brake ECU 9 is started up when a keyless signal from a door ECU or a keyless ECU etc. is input to signal input means built into the brake ECU 9, and the processing shown in FIG. 5 is executed.

First, at step 100, pre-start up mode setting is performed. First, as advance preparation for the present processing, ID information of each of keyless portable devices that are held by individual drivers is associated, respectively, with the plurality of patterns of characteristics that are set as described in the second embodiment, and is saved in advance in the brake ECU 9. Then, in this pre-start up mode setting, when a keyless signal is received, for example, the brake ECU 9 is started up, and ID recognition is performed, by checking the ID information of each of the drivers saved in the storage means of the brake ECU 9 against ID information included in the keyless signal. Based on this, from among the plurality of patterns, a pattern is selected that corresponds to the ID information for which the ID has been recognized, and settings are performed that accord with content of the characteristics selection of that pattern. In this case, when the ID information is received, the pattern corresponding to the ID information is selected and is given priority over the pattern set by the characteristics selection dial 16 on the vehicle side. Thus, it is possible to perform characteristics selection that accords with the preferences of the driver who is actually using the vehicle.

In addition, depending on the vehicle, different characteristics adjustment is performed depending on a destination (when exporting to a cold region, for example), and when conditions etc. relating to the destination are set, each of these are also read. For example, the destination is set in advance by saving the destination in the brake ECU 9 at the time of vehicle shipment. Then, the processing advances to step 105, and it is determined whether or not the pre-start up mode setting has been completed. When it has been completed, the processing advances to step 110.

At step 110, first setting of a pre-drive mode is performed. In this processing, as one of the pre-drive mode settings, driver mode setting is performed. Specifically, when the driver moves the adjustment dials 14 and 15 and further moves the characteristics selection dial 16 and the save switch 17, the ID information of the keyless portable device corresponding to the dial value of the characteristics selection dial 16 is changed. Then, based on the newly set ID information, the ID recognition is performed, and the first setting is made to allow setting in accordance with content of the newly saved characteristics selection. Then, the processing advances to step 115, and it is determined whether or not the first setting of the pre-drive mode has been completed. When the first setting has been completed, the processing advances to step 120.

At step 120, second setting of the pre-drive mode is performed. In this processing, as one of the settings of the pre-drive mode, vehicle weight condition setting is performed. Specifically, as the vehicle weight changes in accordance with a number of passengers, including the driver, the vehicle weight condition setting is made so that characteristics depending on that condition can be changed. Then, the processing advances to step 125, and it is determined whether or not the second setting of the pre-drive mode has been completed. When the second setting has been completed, the processing advances to step 130.

At steps 130 to 165, various status determinations are performed. First, at step 130, vehicle status determination is performed. Here, detection signals of the wheel speed sensors are input, further, longitudinal acceleration and lateral acceleration are input, and at the same time as calculating the estimated vehicle speed from the wheel speed, the slip amount or the slip ratio are calculated from the wheel speed and the estimated vehicle body speed. Further, image information of a forward camera and a rearward camera is input, and signals from obstacle sensors, such as a laser radar and corner sonar etc., are input. Further, vehicle-to-vehicle communication and road-vehicle communication are performed, and various sensor information from a raindrop sensor, an outside air temperature sensor, an illumination sensor, a yaw rate sensor, a G sensor etc. are input, and various information is input from a navigation device. In addition, detection signals from a shift position sensor, the operation amount sensor 21, a throttle sensor, a steering angle sensor and so on are also input.

Then, the processing advances to step 135, and it is determined whether or not the vehicle is traveling. Here, it is determined that the vehicle is traveling when a vehicle speed has been generated (vehicle speed≠0). Then, if the vehicle is not traveling, the processing advances to step 140 and when, as preference settings, the driver has moved the adjustment dials 14 and 15 and performed the characteristics adjustment, the content of the adjustment is accepted and preparation is made to allow settings in accordance with the characteristics after the adjustment. However, if the vehicle is traveling, as it is not desirable to change the characteristics during traveling, even if the driver moves the adjustment dials 14 and 15 the characteristics adjustment is not performed.

Next, at step 145, determinations of an environment independent mode are performed. In the environment independent mode, road surface status conditions, such as a road surface friction coefficient μ or a snowy road etc., sloping road conditions, such as an uphill road or a downhill road or a flat road etc., lane recognition conditions that keep the vehicle inside a lane noted on the road surface etc., forward recognition conditions to recognize whether or not there is an obstacle to the front etc., and rearward recognition conditions to recognize whether or not there is an obstacle to the rear etc., are set. These various conditions can be obtained using a known method based on the various information and signals input in the vehicle status determination at step 130. For example, the road surface status conditions can be obtained from the relationship between the braking force and the slip amount or the slip ratio etc. The sloping road conditions can be obtained from a relationship between the longitudinal acceleration and a vehicle wheel acceleration. The lane recognition conditions, and the forward recognition conditions and the rearward recognition conditions can be obtained by analyzing the image information of the forward camera and the rearward camera. The forward recognition conditions and the rearward recognition conditions can also be obtained based on signals from the obstacle sensors, such as the laser radar and the corner sonar etc.

At step 150, determinations of an environment dependent mode are performed. In the environment dependent mode, vehicle-to-vehicle conditions, such as positional relationships between the vehicle itself and another vehicle, road-vehicle conditions, such as positional information of an intersection etc., GPS position conditions indicating a position in the GPS used by the navigation device, weather conditions, such as whether it is raining or not, outside air temperature conditions, such as whether the temperature around the vehicle is below zero, ambient or a high temperature, and day-night conditions for day or night etc., are set. These various conditions can also be obtained using a known method based on the various information and signal input in the vehicle status determination at step 130. For example, the vehicle-to-vehicle conditions and the road-vehicle conditions can be obtained by the vehicle-to-vehicle communication and the road-vehicle communication. The GPS position conditions can be obtained based on the navigation information from the navigation device. The weather conditions, the outside air temperature conditions and day-night conditions can be obtained from the input of the various sensor information from the raindrop sensor, the outside air temperature sensor and the illuminations sensor etc., and from weather guide information included in the navigation information and the road-vehicle communication.

At step 155, determinations of a vehicle motion mode are performed. In the vehicle motion mode, a mode is set in accordance with various controls in which control intervention is performed. For example, in the vehicle motion mode, vehicle speed conditions, such as whether the vehicle is traveling at low speed or is traveling at high speed, longitudinal acceleration conditions, such as whether the vehicle is braking or accelerating, or whether the vehicle is traveling on a slope etc., lateral acceleration conditions, such as whether the vehicle is turning or is traveling on a straight road, or whether it is traveling on a road surface that is laterally inclined (canted) etc., and yaw conditions, such as whether the vehicle is turning or traveling on a straight road, are set. These various conditions can be obtained by a known method based on the various information and signals input in the vehicle status determination at step 130. For example, the vehicle speed conditions can use the estimated vehicle speed calculated from the vehicle wheel speed, the longitudinal acceleration conditions and the lateral acceleration conditions can be obtained from detection signals of a longitudinal acceleration sensor and a lateral acceleration sensor, and the yaw conditions can be obtained from a detection signal of a yaw rate sensor.

At step 160, determinations of an operation assistance mode are performed. In the operation assistance mode, shift operation conditions, such as whether a shift position is forward, reverse or stop, accelerator operation conditions that indicate a traveling state, such as whether the vehicle is accelerating, brake operation conditions that indicate a braking status, such as whether the vehicle is braking, and steering wheel operation conditions that indicate a turning status, such as whether the vehicle is turning as a result of a steering wheel operation, are set. These various conditions can be obtained using a known method based on the various information and signals input in the vehicle status determination at step 130. For example, the shift operation conditions can be detected from a detection signal of the shift position sensor, the accelerator operation conditions can be detected from a detection signal of the throttle sensor, the brake operation conditions can be detected from a detection signal of the operation amount sensor 21, and the steering wheel operation conditions can be detected from a detection signal of the steering angle sensor.

At step 165, determinations of an each wheel control mode are performed. In other words, each wheel is controlled in accordance with various controls in which control intervention is performed. For example, in Antilock Braking System (ABS) control and Pre-Crash Safety (PCS) control, a mode is set that changes the characteristics in line with changing a braking force distribution of the front and rear wheels. Further, in Electronic Stability Control (ESC), a mode is set that changes the characteristics in line with changing a braking force distribution of the left and right wheels.

When the various status determinations are made in this way, the processing advances to step 170 and, based on the results of the various status determinations, it is determined whether or not there is a high level of emergency. For example, when a distance between the vehicle itself and a vehicle in front is short, based on vehicle-to-vehicle communication, when a vehicle status is about to enter into various controls, or when the vehicle status has already entered into the various controls etc., it is determined that there is a high level of emergency. Here, an example will be given of a case in which it is determined that there is a high level of emergency based on results of the various status determinations, but it is possible to set various levels of emergency with the above-described various conditions as parameters, and the determination can be made as to whether or not there is a high level of emergency based on those levels of emergency. Here, when it is determined that there is not a high level of emergency, the processing advances to step 175, and a personal preference-time operation mode is set that prioritizes the preferences of the driver. When it is determined that there is a high level of emergency, the processing advances to step 180 and an emergency-time operation mode is set that prioritizes characteristics that accord with an emergency over the preferences of the driver. Then, when the personal preference-time operation mode has been set, the characteristics corresponding to the adjustment dials 14 and 15 are read out, and when the time of emergency mode has been set, characteristics corresponding to a type of the emergency to be used in an emergency are read out.

Then, the processing advances to step 185 and upstream values, namely the characteristics on the upstream side of the brake device 1, are set. Specifically, the characteristics set at steps 175 and 180 are stored (saved) as deciding values and the saved F-P characteristics and the St-P characteristics are set. After that, at step 190, as upstream measures, the F-P characteristics and the St-P characteristics are changed to the F-P characteristics and St-P characteristics set at step 185. In this way, at the time of braking, it is possible to use the changed F-P characteristics and St-P characteristics as the braking characteristics. Thus, when there is a low likelihood of emergency and the personal preference-time operation mode has been set, it is possible to obtain characteristics of a brake pedal feeling that accords with the preferences of the driver. Further, when there is a high degree of emergency and the time of emergency mode has been set, it is possible not to rely on the preferences of the driver and to obtain characteristics that further increase the safety of the vehicle.

Further, the processing advances to step 195 and in a similar manner to step 185, downstream values, namely, sets the characteristics on the downstream side of the brake device 1 are set. Then, the processing advances to step 200 and executes downstream measures, namely, executes measures to obtain characteristics on the downstream side of the brake device 1 corresponding to the measures on the upstream side. Specifically, first, the F-P characteristics and St-P characteristics that are changed as the above-described upstream measures are set. Then, sensitivity correction corresponding to the set F-P characteristics and St-P characteristics is performed. In other words, when the brake hardness (the correction reaction force amount) on the upstream side of the brake device 1 has been hardened by the characteristics adjustment, a state is obtained in which it is difficult for the driver to depress the brake pedal 2, and in contrast, when the brake hardness has been softened, a state is obtained in which it is easy for the driver to depress the brake pedal 2. Similarly, when the brake effectiveness (the correction servo amount) has been increased, a state is obtained in which the wheels easily slip due to the depression of the brake pedal 2 by the driver, and in contrast, if the brake effectiveness has been reduced, a state is obtained in which the wheels do not easily slip. Therefore, threshold values of various controls are changed in accordance with the characteristics adjustment on the upstream side, and control sensitivity is varied.

FIG. 6 is a flowchart showing, in detail, the processing executed in the downstream measures. As shown in FIG. 6, at step 300, threshold values of ABS control, PCS control and ESC control are corrected in accordance with the brake hardness (the correction reaction force amount) and the effectiveness (the correction servo amount). Specifically, based on maps shown in step 300, correction coefficients of threshold values of various controls are set. Here, settings are made based on separately provided maps. Respectively, sensitivity correction is set that decides a control start outside of when various controls are being performed, specifically, in a condition before the start of control, and sensitivity correction is set during controls, specifically, when performing control intervention once more after the start of control. Note that, in FIG. 6, maps of the correction coefficients of the sensitivity correction outside of controls are shown, and maps of the correction coefficients of the sensitivity correction during controls are not shown. However, for example, the maps of the correction coefficients during controls are maps in which inclinations of the maps setting the correction coefficients of the sensitivity correction are changed with respect to the maps of the correction coefficients of the sensitivity correction outside controls.

For example, in the sensitivity correction, the harder the brake hardness becomes and the larger the correction reaction force amount becomes, correction coefficients are set that decrease the threshold values of each of the controls, such that the control intervention is applied even if a control amount (the slip amount, the slip ratio, for example) is smaller and the slip is mild. In contrast, the softer the brake hardness becomes and the smaller the correction reaction force becomes, correction coefficients are set that increase the threshold values of each of the controls, such that control intervention is not applied until a control amount (the slip amount, the slip ratio, for example) is larger and the slip becomes more severe. Further, the more the brake effectiveness is increased and the larger the correction servo amount becomes, correction coefficients are set that increase the threshold values of each of the controls, such that control intervention is not applied until a control amount (the slip amount, the slip ratio, for example) is larger and the slip becomes more severe. In contrast, the more the brake effectiveness is decreased and the smaller the correction servo amount becomes, correction coefficients are set that decrease the threshold values of each of the controls, such that the control intervention is applied even if a control amount (the slip amount, the slip ratio, for example) is smaller and the slip is milder. Note that here, an example is given in which, with respect to each of the controls, each of the correction coefficients of the sensitivity correction is set as a proportional straight line (a linear straight line) depending on the brake hardness and effectiveness. However, it is not limited to the example shown in these maps. For example, it need not necessarily be a proportional straight line, and may be a proportional straight line of a different gradient when the brake hardness becomes hard and soft or when the brake effectiveness is increased and decreased under normal conditions, or may be a curved line.

In this way, when the correction coefficients of the sensitivity correction are decided in accordance with the characteristics adjustment of the brake hardness and effectiveness, the processing advances to step 305, and average values of the correction coefficients of the sensitivity correction decided in accordance with the characteristics adjustment of the brake hardness and effectiveness are calculated. These are taken as the final correction coefficients of the sensitivity correction, and are transmitted to an application that executes the processing of the various controls, such that they are used in the threshold value correction of the various controls. In this manner, in the application that executes the processing of the various controls, the threshold value correction is performed by multiplying the received correction coefficients with threshold values at a time of normal operation.

After that, the processing advances to step 205 in FIG. 5, and, using a similar method to that at step 135, it is determined whether or not the vehicle is traveling. When the vehicle is not traveling, it is possible that the number of passengers may have increased or decreased, and thus the processing from step 120 is repeated. When the vehicle is traveling, the processing from step 130 is repeated.

As described above, at the same time as performing the measures on the upstream side of the brake device 1, the sensitivity correction of the various brake fluid pressure controls is performed as measures on the downstream side. In this way, while performing characteristics changes in accordance with the preferences of the driver on the upstream side of the brake device 1, sensitivity correction of the various controls on the downstream side are performed accordingly, and it is thus possible to appropriately change the threshold values of the various brake fluid pressure controls in correspondence with the characteristics changes on the upstream side. Further, in the measures on the upstream side of the brake device 1 also, when it is not a time of an emergency, the preferences of the driver are given priority, but when it is a time of an emergency, the safety of the vehicle in accordance with demands from the vehicle side is given priority over the preferences of the driver. In this way, it is possible to secure the safety of the vehicle while also performing the characteristics adjustment in accordance with the preferences of the driver.

### Other Embodiments

The present invention is not limited to the above-described embodiments, and various changes can be made as appropriate without departing from the scope of the claims.

For example, in the above-described fourth embodiment, the ABS control, the PCS control and the ESC control are given as an example of the case in which the adjustment of the characteristics of the brake fluid pressure control executed in the brake fluid pressure control actuator 5 on the downstream side is performed in accordance with the characteristics adjustment on the upstream side of the brake device 1. However, these are merely examples of the brake fluid pressure control, and the same control can be applied to other braking systems, such as Electronic Brake Force Distribution (EBD) control and traction (TRC) control etc. Further, an example is given in which, when performing the characteristics adjustment on the downstream side, threshold value correction is performed as the correction of the control amount of the brake fluid pressure control, and the correction coefficient (namely, a proportional term) that is multiplied with the threshold value as the correction amount used in the threshold value correction is calculated. However, a constant term may be calculated by adding a fixed amount to the threshold value as the correction amount, or the threshold value correction may be performed by combining the proportional term and the constant term.

In addition, in each of the above-described embodiments, the example is given of the brake device 1 and explained, but another configuration may be adopted, as long as the configuration is provided with a reaction force generating portion that generates the reaction force hydraulic pressure in the reaction force chamber 303 and with an electric pressure adjustment portion that generates the driving hydraulic pressure in the driving hydraulic pressure chamber 316, and as long as it is possible to independently control the reaction force hydraulic pressure using the reaction force generating portion, and to independently control the driving hydraulic pressure using the electric pressure adjustment portion. For example, in the brake device 1 shown in FIG. 1, by disposing the first and second control valves 6a and 6b that are included in the reaction force generating portion and the electric pressure adjustment portion inside the inter-chamber brake fluid path, some of the control valves that configure the valve device are shared. However, a control valve that shuts off the inter-chamber brake fluid path and control valves that are respectively provided in the reaction force generating portion and the electric pressure adjustment portion may be provided separately from each other.

Further, as the adjustment mechanism that performs the characteristics adjustment, the example is given of the adjustment dials 14 and 15 and explained, but another adjustment mechanism may be used, such as an adjustment switch etc.

Furthermore, in the above-described embodiments, the ID information of the keyless portable device is used as the ID information to perform the ID recognition for each driver, but ID information of an ID card etc. that is held by each individual driver and that is capable of communication may be used. In other words, as long as a portable device that can be carried by the driver outside the vehicle is provided with a function to transmit a signal including the ID information, and the signal received on the vehicle side, the portable device can be used in the pattern selection of the characteristics according to the preferences of each driver.

In addition, in the above-described fourth embodiment, the average value of the correction coefficients of the sensitivity correction decided in accordance with the characteristics adjustment of each of the brake hardness and effectiveness is used as the final correction coefficient of the sensitivity correction, but either the larger or the smaller correction coefficient may be used as the final correction coefficient of the sensitivity correction, rather than the average value.

Note that the steps shown in each of the figures correspond to means that execute the various processing. Specifically, of the brake ECU 9, a portion that executes the processing at step 170 corresponds to time of emergency determination means, and a portion that executes the processing at step 180 corresponds to time of emergency characteristics setting means.

### REFERENCE SIGNS LIST

1 Brake device
2 Brake pedal
3 M/C
4a to 4d W/C
5 Brake fluid pressure control actuator
6a to 6e First to fifth control valves
7 Pump
8 Motor
10 Atmospheric pressure reservoir
12, 13 Pressure sensor
14, 15 Adjustment dial
16 Characteristics selection dial
17 Save switch
21 Operation amount sensor
30 Input portion
31 Output portion
301 Input piston
302 Cylinder portion
303 Reaction force chamber
304 Back chamber
311, 312 M/C piston
313 Cylinder portion
316 Driving hydraulic pressure chamber
317 Primary chamber
318 Secondary chamber
A to E Conduit

1. A brake device characterized by comprising:
a master cylinder that forms a driving hydraulic pressure chamber that drives a master piston by a supply and discharge of brake fluid, and also forms a reaction force chamber that is compressed or expanded in accordance with operation of a brake operating member;
an electric pressure adjustment portion that adjusts a driving hydraulic pressure of the driving hydraulic pressure chamber by supplying the brake fluid to the inside of the driving hydraulic pressure chamber or by discharging the brake fluid from the inside of the driving hydraulic pressure chamber; and
a reaction force generating portion that generates a reaction force hydraulic pressure inside the reaction force chamber in accordance with an operation amount of the brake operating member;
wherein
the brake device is provided with an adjustment mechanism which, by being adjusted by a driver and controlling the electric pressure adjustment portion and the reaction force generating portion, changes at least one of F-P characteristics and St-P characteristics independently from each other with respect to initial setting characteristics that are set in advance as the F-P characteristics and the St-P characteristics, the F-P characteristics being characteristics of a brake operation force F of the brake operating member and of a brake fluid pressure P output from the master cylinder, the St-P characteristics being characteristics of an operation amount St of the brake operating member and of the brake fluid pressure P,

2. The brake device according to claim 1, characterized by comprising:
storage means capable of storing a plurality of patterns for adjustment of at least one of the F-P characteristics and the St-P characteristics by the adjustment mechanism; and
characteristics selection means for selecting a pattern from among the plurality of patterns saved in the storage means.

3. The brake device according to claim 2, wherein
at a time of engine start up, from among the plurality of patterns saved in the storage means, a pattern selected by the characteristics selection means at the time of the engine start up is selected.

4. The brake device according to claim 2, wherein
ID information for each driver and each of the plurality of patterns are saved in the storage means in a manner that the ID information for each driver is associated with corresponding one of the plurality of patterns, and
the brake device further comprises
signal input means for inputting ID information for each driver that is received from a portable device that outputs a signal including ID information, and
means for selecting, from the plurality of patterns, a pattern corresponding to the ID information input by the signal input means in priority to over the pattern selected by the characteristics selection means.

5. The brake device according to claim 1, characterized by comprising:
vehicle condition detection means for detecting a vehicle condition, the vehicle condition being at least one of a traveling environment and a traveling state of the vehicle;
wherein
the adjustment of the at least one of the F-P characteristics and the St-P characteristics is performed based on the vehicle condition detected by the vehicle condition detection means.

6. The brake device according to claim 5, wherein
the vehicle condition detection means obtains navigation information showing the traveling environment of the vehicle, and performs the adjustment of the at least one of the F-P characteristics and the St-P characteristics based on environment parameters shown in the navigation information.

7. The brake device according to claim 5, wherein
the vehicle condition detection means detects a vehicle speed as the traveling state of the vehicle, and performs the adjustment of the at least one of the F-P characteristics and the St-P characteristics based on the vehicle speed.

8. The brake device according to claim 1, characterized by comprising:
time of emergency determination means for determining whether it is a time of emergency; and
time of emergency characteristics setting means that, when it is determined by the time of emergency determination means that it is not the time of emergency, performs the adjustment of the F-P characteristics and the St-P characteristics based on the adjustment by the adjustment mechanism, and when it is determined that it is the time of emergency, performs the adjustment of the F-P characteristics and the St-P characteristics for the time of emergency that are set based on a vehicle condition, in priority to the adjustment by the adjustment mechanism.

9. The brake device according to claim 1, characterized by comprising:
a brake fluid pressure control actuator provided between the master cylinder and a wheel cylinder; and
control means for executing brake fluid pressure control in which the brake fluid pressure P output from the master cylinder is controlled using the brake fluid pressure control actuator and is transmitted to the wheel cylinder;
wherein
the control means corrects a control amount of the brake fluid pressure control in accordance with changes in the F-P characteristics and the St-P characteristics.

10. The brake device according to claim 9, wherein
as correction of the control amount, the control means performs correction in accordance with the changes in the F-P characteristics and the St-P characteristics with respect to at least one of a proportional term and a constant term that corrects a threshold value of the brake fluid pressure control.
